(19) United States
(12) Patent Application Publication
(10) Pub. No.: US 2009/0253332 A1
(43) Pub. Date: Oct. 8, 2009

(54) ASSEMBLING METHOD OF LIQUID CRYSTAL DISPLAY PANEL

(76) Inventors: Hongming ZHAN, Beijing (CN); Dongki OH, Beijing (CN); Jinmahn KIM, Beijing (CN)

Correspondence Address: LADAS & PARRY LLP, 224 SOUTH MICHIGAN AVENUE, SUITE 1600, CHICAGO, IL, 60604, US

(21) Appl. No.: 12/414,851

(22) Filed: Mar. 31, 2009

(30) Foreign Application Priority Data
Apr. 3, 2008 (CN) 200810103439.1

(51) Int. Cl. G02F 1/1339

(52) U.S. Cl. 445/24

(57) ABSTRACT

Disclosed is an assembling method of LCD panel comprising the following steps. In step one, a plurality of spherical spacers are mixed with a liquid crystal solution so as to form a mixed liquid crystal solution with spherical spacers dispersed uniformly in the liquid crystal solution. In step two, a seal agent is applied onto edge portions of a first substrate and the mixed liquid crystal solution is applied onto a second substrate by dropping. In step three, the first and second substrates are assembled, spreading the mixed liquid crystal solution therebetween so as to dispose the spherical spacers uniformly between the first and second substrates.

### BACKGROUND

Embodiments of the present invention relate to an assembling method of a liquid crystal display panel.

The fabrication process of liquid crystal displays (LCDs) has been developed over the last decades due to the popularity of LCDs. As one of the major components of a LCD, a LCD panel typically at least comprises an array substrate and a color filter substrate with a liquid crystal layer therebetween. The liquid crystal layer can serve as a light valve with the electric field applied across the liquid crystal layer so as to adjust the polarization of the light passing therethrough due to the anisotropic electro-optical property of liquid crystal. Thus thickness control of the liquid crystal layer is a factor directly affecting the light adjustment of the liquid crystal layer in the fabrication process of the LCD panel. Therefore, thickness uniformity of the liquid crystal layer plays an important role in achieving high display quality for LCDs.

In order to obtain the thickness uniformity of a liquid crystal layer, one of the commonly used methods is applying spacers in the liquid crystal panel. The spacer may be in a post or spherical shape, with spherical shape being more typical. According to a convention method for assembling a LCD panel by applying spherical spacers, the spherical spacers are spread onto an array substrate or a color filter substrate by spraying, and then the substrates are assembled together and the overall thickness of the liquid crystal layer is controlled with size uniformity of the spherical spacers. FIG. 1 is a schematic view showing a conventional wet distribution method of spherical spacers. As shown in FIG. 1, the spherical spacers 2 are firstly dispersed in a volatile liquid 3. Then the volatile liquid 3 with the spherical spacers 2 therein is sprayed onto the substrate 4 by a sprayer 1. FIG. 2 is a schematic view showing a conventional dry distribution method of spherical spacers. As shown in FIG. 2, the spherical spacers 2 are first dispersed in the dried gas such as nitrogen or air, and then the dried gas with the spacers 2 therein is sprayed onto the substrate 4 by a sprayer 1′. FIG. 3-FIG. 6 show schematic views showing a conventional assembling method of a LCD panel comprising four steps as following. First, the spherical spacers 2 are sprayed onto a color filter substrate 6, as shown in FIG. 3. Then a seal agent is applied to the edge portions of the color filter substrate 6 with the spherical spacers sprayed thereon, as shown in FIG. 4. Next, liquid crystal is dropped onto an array substrate 8, as shown in FIG. 5. Finally, the color filter substrate 6 and the array substrate 8 obtained in the above steps are assembled together to form a LCD panel 10, as shown in FIG. 6. It can be seen that some of the spacers might be positioned outside of the seal agent, that is, outside of the pixel region when applied on the color filter substrate. There are other convention methods for forming a LCD panel, such as injection method by assembling the color filter substrate 6 and the array substrate 8 together first and then injecting liquid crystal.

### SUMMARY

In an embodiment of the present invention, there is provided an assembling method of a liquid crystal display (LCD) panel comprising the following steps. In step one, a plurality of spherical spacers are mixed with a liquid crystal solution so as to form a mixed liquid crystal solution with spherical spacers being dispersed uniformly in the liquid crystal solution. In step two, a seal agent is applied onto edge portions of a first substrate and the mixed liquid crystal solution is applied onto a second substrate by dropping. In step three, the first and second substrates are assembled, spreading the mixed liquid crystal solution therebetween so as to dispose the spherical spacers uniformly between the first and second substrates.

Preferably, in step one, the mixed liquid crystal solution can be stirred at a speed in a range of 50 RPM to 300 RPM for more than 10 minutes. Alternatively, the mixed liquid crystal solution can be vibrated at a speed in a range of 50 stroke/minute to 300 stroke/minute for more than 30 minutes. Alternatively, the mixed liquid crystal solution can be subjected to an ultrasonic treatment with a frequency in a range of 20 kHz to 40 kHz for more than 10 minutes.

Preferably, in step two, the seal agent can be applied onto a color filter substrate and the mixed liquid crystal solution can be applied onto an array substrate by dropping at a speed of 100-1000 drop/minute with 1-5 mg per drop. Alternatively, the seal agent can be applied onto the array substrate and the mixed liquid crystal solution can be applied onto the color filter substrate by dropping at a speed of 100-1000 drop/minute with 1-5 mg per drop.

According to the embodiments of the present invention, the density and uniformity of the spherical spacers can be precisely controlled by mixing the spherical spacers in the liquid crystal solution, thus improving the distribution uniformity of the spherical spacers in the LCD panel and thickness uniformity of the LCD panel and preventing the spherical spacers from being outside of the seal agent. Thus the quality as well as yield of the LCD panel can be improved accordingly.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a schematic view illustrating a conventional wet distribution method of spherical spacers;

FIG. 2 is a schematic view illustrating a conventional dry distribution method of spherical spacers;

FIGS. 3-6 are schematic views illustrating a conventional assembling method of LCD panel;

FIG. 7 is a flow chart of an assembling method according to a first embodiment of the invention;

FIG. 8 is a schematic view showing a step of mixing liquid crystal solution with spherical spacers according to the first embodiment of the invention;

FIG. 9 is a schematic view showing a step of applying seal agent onto a color filter substrate according to the first embodiment of the invention;

FIG. 10 is a schematic view showing a step of dropping the mixed liquid crystal solution onto an array substrate;

FIG. 11 is a schematic view showing a step of an assembling method of the color filter substrate and the array substrate; and

FIG. 12 is a flow chart illustrating of an assembling method according to a second embodiment of the invention.

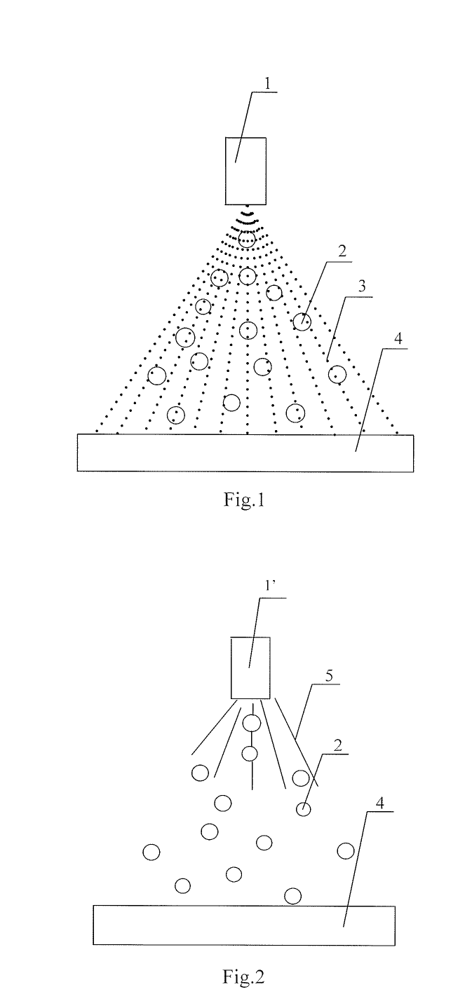

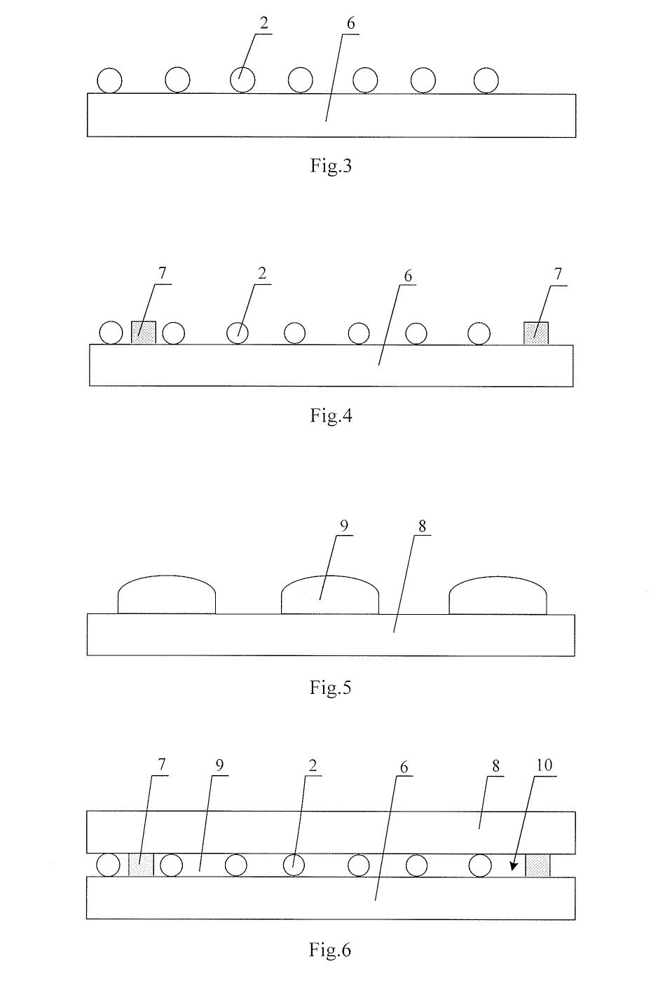

### DETAILED DESCRIPTION OF EMBODIMENTS

### First Embodiment

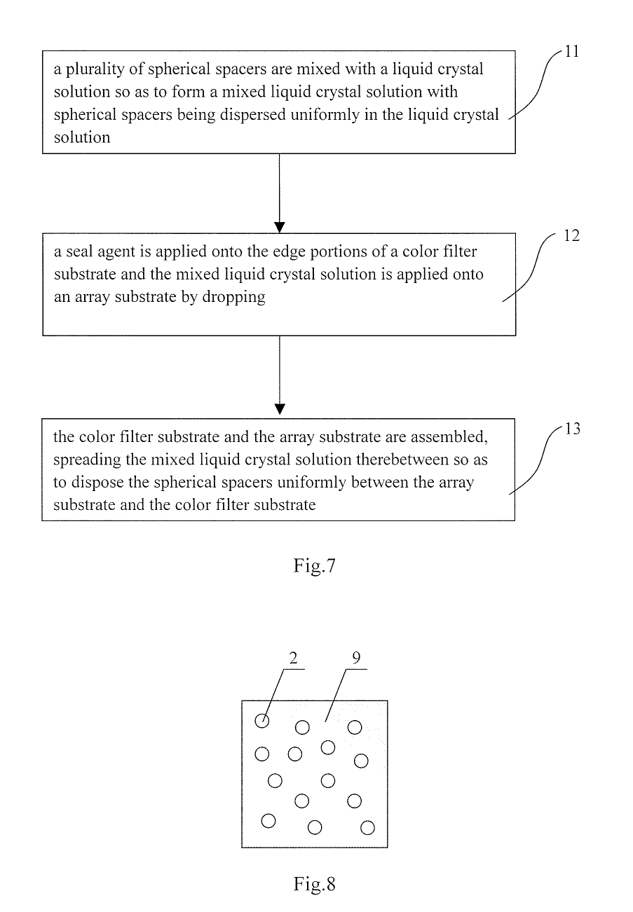

FIG. 7 is a flow chart of an assembling method according to a first embodiment of the invention. As shown in FIG. 7, the assembling method according to the first embodiment comprises the following steps. In step 11, a plurality of spherical spacers are mixed with a liquid crystal solution so as to form a mixed liquid crystal solution with spherical spacers being dispersed uniformly in the liquid crystal solution. In step 12, a seal agent is applied onto the edge portions of a color filter substrate and the mixed liquid crystal solution is applied onto an array substrate by dropping. In step 13, the color filter substrate and the array substrate are assembled, spreading the mixed liquid crystal solution therebetween so as to dispose the spherical spacers uniformly between the array substrate and the color filter substrate.

According to the first embodiment of the present invention, the density and uniformity of the spherical spacers can be precisely controlled by mixing the spherical spacers in the liquid crystal solution, thus improving the distribution uniformity of the spherical spacers in a LCD panel and improving thickness uniformity of the LCD panel and preventing the spherical spacers from being outside of the seal agent. Thus the quality as well as yield of LCD panels can be improved accordingly.

The first embodiment of the invention is further described in detail hereafter.

FIG. 8 is a schematic view showing a step of mixing liquid crystal solution with spherical spacers according to the first embodiment of the invention. In the above step, the spherical spacers 2 are uniformly dispersed in the liquid crystal solution 9 so as to form a uniformly mixed liquid crystal solution. Firstly, the spherical spacers and a pure liquid crystal solution are weighted based on design values, and then the spacers and the liquid crystal solution are mixed together in order to disperse the spacers into the liquid crystal solution. Thus mixed solution can not be set too long before being applied onto a substrate since the distribution of spherical spacers 2 may vary with the time due to gravity, resulting in an inhomogeneous mixed solution, even precipitation or agglomeration of the spacers. The setting time for the mixed liquid crystal solution is preferably less than 60 minutes in the embodiment.

In the above steps, the dispersion method of the spacers can be at least one selected from stirring, vibrating, or ultrasonic treatment method, so that a homogeneous mixed solution can be obtained, as shown in FIG. 8. Preferably, in the above step, the mixed liquid crystal solution can be stirred at a speed in a range of 50 RPM to 300 RPM for more than 10 minutes. Alternatively, the mixed liquid crystal solution can be vibrated at a speed in a range of 50 stroke/minute to 300 stroke/minute for more than 30 minutes. Alternatively, the mixed liquid crystal solution can be subjected to an ultrasonic treatment with a frequency in a range of 20 kHz to 40 kHz for more than 10 minutes. Furthermore, the stirring method, the vibrating method or the ultrasonic treatment method can be used alternatively or cooperatively to improve the dispersion efficiency. For example, two or more than two methods can be used to treat the same mixed solution.

The density and uniformity of the mixed liquid crystal solution can be precisely controlled by weighing based on the designed values. The spacers can be uniformly distributed in the liquid crystal solution by stirring, vibrating or ultrasonic treatment or any combination thereof. Furthermore, the spraying process in a conventional method can be omitted by dispersing the spacers in the liquid crystal solution, thus improving the production efficiency.

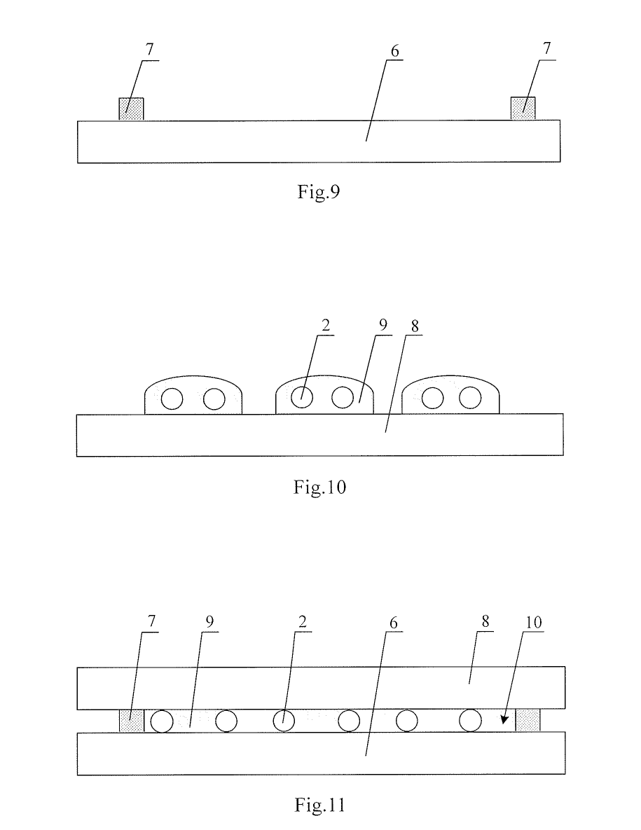

FIG. 9 is a schematic view showing a step of applying seal agent onto a color filter substrate according to the first embodiment of the invention. In the present embodiment, the seal agent 7 can be applied onto the edge portions of a color filter substrate 6, as shown in FIG. 9, preventing the mixed liquid crystal solution from overflowing outside of the pixel region and thereby controlling distribution area of the mixed liquid crystal solution. By applying the seal agent first onto the color filter substrate other than applying the spacers first onto the substrate in a conventional method, it is easier to apply the seal agent and it also can prevent the spacers from being outside of the seal agent.

FIG. 10 is a schematic view showing a step of applying the mixed liquid crystal solution onto an array substrate by dropping. In the present embodiment, the mixed liquid crystal solution can be applied onto an array substrate by dropping at a speed of 100-1000 drop/minute with 1-5 mg per drop. The mixed liquid crystal solution can be applied onto the array substrate more uniformly by dropping, thus the mixed solution is easier to be spread in a subsequent process.

FIG. 11 is a schematic view showing a step of the assembling method of the color filter substrate and the array substrate. In the present embodiment, the color filter substrate 6 and the array substrate 8 are assembled together, thus spreading the mixed liquid crystal solution and disposing the spherical spacers uniformly between the two substrates, as shown in FIG. 11. After the color filter substrate 6 and the array substrate 8 are assembled together, the spacers 2 can flow with the liquid crystal solution and dispose uniformly in the LCD panel. The parameters in above process will be affected by the viscosity of the liquid crystal solution 9, thickness of the LCD panel 10, the size and density of the spherical spacers 2, and the assembling strength between the color filter substrate 6 and the array substrate 8, as well as the spreading speed of the liquid crystal solution 9, etc., which can be adjusted independently or collectively as necessary.

According to the first embodiment of the present invention, the density and uniformity of the spherical spacers can be precisely controlled by mixing the spherical spacers in the liquid crystal solution, thus improving the distribution uniformity of the spherical spacers in the LCD panel and thickness uniformity of the LCD panel and preventing the spherical spacers from being outside of the seal agent. Thus the quality as well as yield of the LCD panel can be improved accordingly.

### Second Embodiment

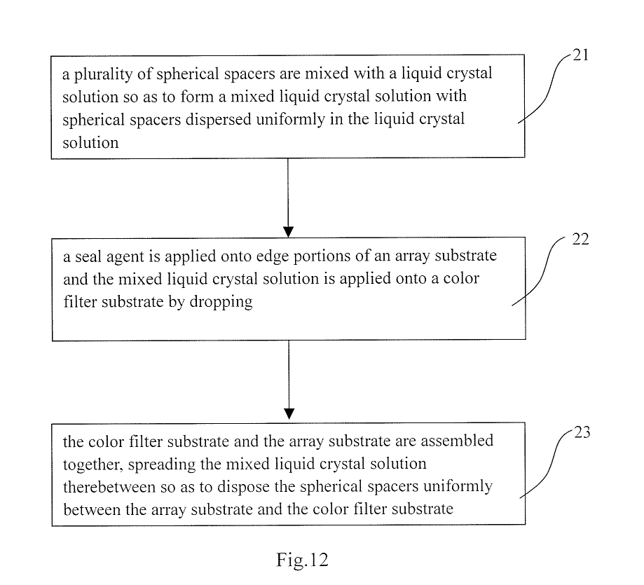

FIG. 12 is a flow chart illustrating of an assembling method according to a second embodiment of the invention. As shown in FIG. 12, the assembling method according to the second embodiment comprises the following steps. In step 21, a plurality of spherical spacers are mixed with a liquid crystal solution so as to form a mixed liquid crystal solution with spherical spacers dispersed uniformly in the liquid crystal solution. In step 22, a seal agent is applied onto edge portions of an array substrate and the mixed liquid crystal solution is applied onto a color filter substrate by dropping. In step 23, the color filter substrate and the array substrate are assembled together, spreading the mixed liquid crystal solution therebetween so as to dispose the spherical spacers uniformly between the array substrate and the color filter substrate.

The second embodiment is substantially same as the first embodiment, except that, unlike the first embodiment of the invention, the seal agent is applied onto the array substrate instead of the color filter substrate, and the mixed liquid crystal solution can be applied onto a color filter substrate by dropping at a speed of 100-1000 drop/minute with 1-5 mg per drop in the second embodiment. The repetitive description of the second embodiment is omitted for the sake of simplicity.

The invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

What is claimed is:

1. An assembling method of a liquid crystal display (LCD) panel, comprising:
step one of mixing a plurality of spherical spacers with a liquid crystal solution so as to form a mixed liquid crystal solution with spherical spacers being dispersed uniformly in the liquid crystal solution;
step two of applying a seal agent onto edge portions of a first substrate and applying the mixed liquid crystal solution onto a second substrate by dropping; and
step three of assembling the first and second substrates, spreading the mixed liquid crystal solution therebetween so as to dispose the spherical spacers uniformly between the first and second substrates.

2. The assembling method of a LCD panel according to claim 1, wherein in step one, the mixed liquid crystal solution is stirred at a speed in a range of 50 RPM to 300 RPM for more than 10 minutes.

3. The assembling method of a LCD panel according to claim 1, wherein in step one, the mixed liquid crystal solution is vibrated at a speed in a range of 50 stroke/minute to 300 stroke/minute for more than 30 minutes.

4. The assembling method of a LCD panel according to claim 1, wherein in step one, the mixed liquid crystal solution is subjected to an ultrasonic treatment with a frequency in a range of 20 kHz to 40 kHz for more than 10 minutes.

5. The assembling method of a LCD panel according to claim 1, wherein the first substrate is a color filter substrate, the second substrate is an array substrate, and in step two, the mixed liquid crystal solution is applied onto the array substrate by dropping at a speed of 100-1000 drop/minute with 1-5 mg per drop.

6. The assembling method of a LCD panel according to claim 2, wherein the first substrate is a color filter substrate, the second substrate is an array substrate, and in step two, the mixed liquid crystal solution is applied onto the array substrate by dropping at a speed of 100-1000 drop/minute with 1-5 mg per drop.

7. The assembling method of a LCD panel according to claim 3, wherein the first substrate is a color filter substrate, the second substrate is an array substrate, and in step two, the mixed liquid crystal solution is applied onto the array substrate by dropping at a speed of 100-1000 drop/minute with 1-5 mg per drop.

8. The assembling method of a LCD panel according to claim 4, wherein the first substrate is a color filter substrate, the second substrate is an array substrate, and in step two, the mixed liquid crystal solution is applied onto the array substrate by dropping at a speed of 100-1000 drop/minute with 1-5 mg per drop.

9. The assembling method of a LCD panel according to claim 1, wherein the first substrate is an array substrate, the second substrate is a color filter substrate, and in step two, the mixed liquid crystal solution is applied onto the color filter substrate by dropping at a speed of 100-1000 drop/minute with 1-5 mg per drop.

10. The assembling method of a LCD panel according to claim 2, wherein the first substrate is an array substrate, the second substrate is a color filter substrate, and in step two, the mixed liquid crystal solution is applied onto the color filter substrate by dropping at a speed of 100-1000 drop/minute with 1-5 mg per drop.

11. The assembling method of a LCD panel according to claim 3, wherein the first substrate is an array substrate, the second substrate is a color filter substrate, and in step two, the mixed liquid crystal solution is applied onto the color filter substrate by dropping at a speed of 100-1000 drop/minute with 1-5 mg per drop.

12. The assembling method of a LCD panel according to claim 4, wherein the first substrate is an array substrate, the second substrate is a color filter substrate, and in step two, the mixed liquid crystal solution is applied onto the color filter substrate by dropping at a speed of 100-1000 drop/minute with 1-5 mg per drop.
